(19) United States
(12) Patent Application Publication
(10) Pub. No.: US 2017/0341251 A1
(43) Pub. Date: Nov. 30, 2017

(54) Rotary Cutter

(71) Applicant: Acme United Corporation, Fairfield, CT (US)

(72) Inventors: Nicole Siciliano, Stamford, CT (US); Sarah A. Albano, Fairfield, CT (US); Steven C. Cozzolino, New York, NY (US); Cody Stonerock, Brooklyn, NY (US); Peter F. Kristiansen, Nutley, NJ (US); Lyndon Treacy, Brooklyn, NY (US)

(21) Appl. No.: 15/609,200

(22) Filed: May 31, 2017

Related U.S. Application Data
(60) Provisional application No. 62/343,267, filed on May 31, 2016.
(60) Provisional application No. 62/436,153, filed on Dec. 19, 2016.

(51) Int. Cl. B26B 25/00; B25G 1/08

(52) U.S. Cl. CPC B26B 25/005; B25G 1/08

(57) ABSTRACT

A rotary cutter comprises a body having a handle and a cutter opening. A reservoir of rotary blades is disposed in the body. A member is moveable between a protective and an exposed operative position. A releasable blade receiver assembly allows a blade to be ejected from the cutter and a replacement blade to be loaded onto the cutter for subsequent usage.

### CROSS-REFERENCE TO RELATED APPLICATIONS

This application claims the priority of U.S. Provisional Patent Application Nos. 62/343,267 filed on May 31, 2016 and 62/436,153 filed on Dec. 19, 2016, the disclosures of which applications are incorporated herewith by reference in their entirety.

### BACKGROUND

This disclosure relates generally to manual cutters which employ a rotary blade. More particularly, this disclosure relates to rotary cutters employed for crafting applications.

### SUMMARY

Briefly stated, a rotary cutter comprises a body having a handle and a cutter opening. A reservoir of rotary blades is disposed in the body. A member is moveable between a protective and an exposed operative position. A releasable blade receiver assembly is mounted to the body. The assembly preferably comprises a pivoted lever arm having an actuator. A spring biases the pivoted lever arm to a first position. A bottom structure is engageable with the lever at the first position. A slide axle assembly is activatable by the actuator to engage a rotary blade to permit rotation thereof and to disengage the blade. A button exteriorly of the body is actuatable to retract the slide axle assembly. The slide axle assembly is engageable with a blade in a first position and is disengageable from the blade to release the blade in a second position.

The rotary blades may be substantially identical. The rotary blades may be specialty blades selected from the group consisting of a straight blade, a perforated blade, a wave blade and a pinking blade. In the protective position, the cutting edge of the blade is not exteriorly exposed.

A method for replacing a blade in a rotary cutter without a user contacting the blade comprises sliding a button and depressing the button to release the blade. The method comprises ejecting the blade from the cutter and sliding the button to engage a replacement blade. The method further comprises moving the button to secure the replacement blade for usage. The method further comprises locking the replacement blade at either a protected or an exposed position.

### BRIEF DESCRIPTION OF THE DRAWINGS

FIG. 1 is a front view, partly in diagram form and portions shown in phantom, of a rotary cutter;

FIG. 2 is a rear view of the rotary cutter of FIG. 1;

FIG. 3 is a top plan view, partly in diagram form, of the rotary cutter of FIG. 1;

FIG. 4 is a bottom plan view of the rotary cutter of FIG. 1;

FIG. 5 is an enlarged cutter end view, partly in diagram form, of the rotary cutter of FIG. 1;

FIG. 6 is an enlarged side view, partly in schematic, of the blade replacement mechanism for the rotary cutter of FIG. 1;

FIG. 7 is a generally top view, partly in schematic, of the blade replacement mechanism together with a receptacle of replacement blades in a first operative position;

FIG. 8 is a generally top schematic view of the blade replacement mechanism together with replacement blades illustrating a second operative position;

FIG. 9 is a generally top schematic view of the blade replacement mechanism together with the replacement blades illustrating a third operative position;

FIG. 10 is a generally top schematic view of the replacement mechanism and replacement blades illustrating a fourth operative position;

FIG. 11 is a generally top schematic view of the replacement mechanism together with a reservoir of replacement blades illustrating a fifth operative position;

FIG. 12 is a generally top schematic view of the replacement mechanism illustrating a sixth operative position;

FIG. 13 is a side view of a pinking blade that may be employed in the rotary cutter;

FIG. 14 is a photograph of a straight blade, a perforated blade, a wave blade and a pinking blade which may be employed in the rotary cutter;

FIG. 15 is a photograph of a front side view of another embodiment of a rotary cutter;

FIG. 16 is a photograph of a top plan view of the rotary cutter of FIG. 15;

FIG. 17 is a perspective view, exterior portions removed, of the rotary cutter of FIG. 15;

FIG. 18 is a front side view, exterior portions removed, partly in diagram form and portions shown in phantom, of the rotary cutter of FIG. 15;

FIG. 18A is an enlarged annotated view of the rotary cutter of FIG. 18;

FIG. 19 is a rear side view, exterior portions removed, of the rotary cutter of FIG. 15;

FIG. 19A is an enlarged annotated view of the rotary cutter of FIG. 19;

FIG. 20 is a top plan view, exterior portions removed, partly in diagram form, of the rotary cutter of FIG. 15;

FIG. 21 is a bottom plan view, exterior portions removed, of the rotary cutter of FIG. 15;

FIG. 22 is an enlarged cutter end view, exterior portions removed, of the rotary cutter of FIG. 15;

FIG. 23 is an enlarged opposite end view, exterior portions removed, of the rotary cutter of FIG. 15;

FIGS. 24A and 24B are exploded views of the rotary cutter of FIG. 17;

FIG. 25 is a front side view of the rotary cutter of FIG. 18 further illustrating section lines;

FIG. 26 is an enlarged sectional view of the rotary cutter of FIG. 25 taken along the line B-B thereof;

FIG. 27 is an enlarged annotated sectional view of the rotary cutter of FIG. 25 taken along the line C-C with the rotary cutter in a first operative position;

FIG. 28 is an enlarged annotated sectional view of the rotary cutter of FIG. 25 taken along the line C-C thereof with the rotary cutter in a second operative position; and

FIGS. 29A and 29B are enlarged annotated perspective views of the rotary cutter of FIG. 17 with a blade cover in an opened position and the cutter blades illustrated removed from a blade receptacle and loaded into the blade receptacle, respectively.

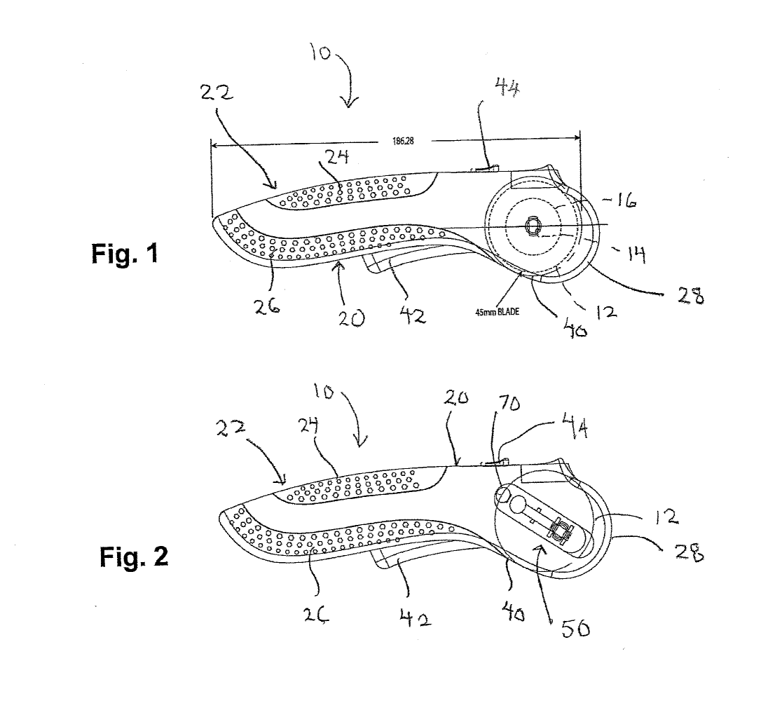

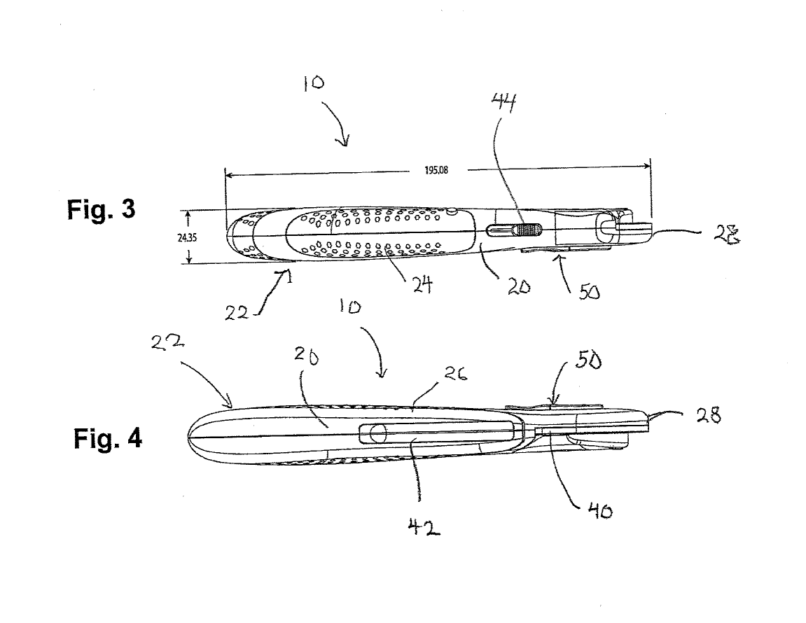

### DETAILED DESCRIPTION

With reference to the drawings wherein like numerals represent like parts throughout the several figures, a rotary cutter, which is specially adaptable for crafting applications, is generally designated by the numeral 10. Rotary cutter 10 is adapted to replace a rotary cutter blade with a replacement cutter blade by means of an efficient mechanism which can be operated without the user touching or handling the rotary blades. The rotary cutter 10 may be configured to handle a wide variety of blades, for example, 28 mm, 45 mm and 60 mm circular blades and various specialty blades. The “no-touch” feature is accomplished without requiring the operator to actually physically touch the discarded blade or the replacement blade.

The rotary cutter 10 has a housing 20 which forms a handle 22 having a contoured form. The handle also has a pair of grip portions 24 and 26 configured to facilitate the manual gripping of the cutter. The housing 20 functions to provide a protective cover for the rotary blades, which in the illustrated embodiment, is designated as blade 12 having a central opening 14 for a 45 mm blade. It should be appreciated that this rotary cutter will be configured and dimensioned for blades of various sizes and types. For purposes of description herein, the principal description will primarily focus on the 45 mm blade 12 and pinking blade 12C.

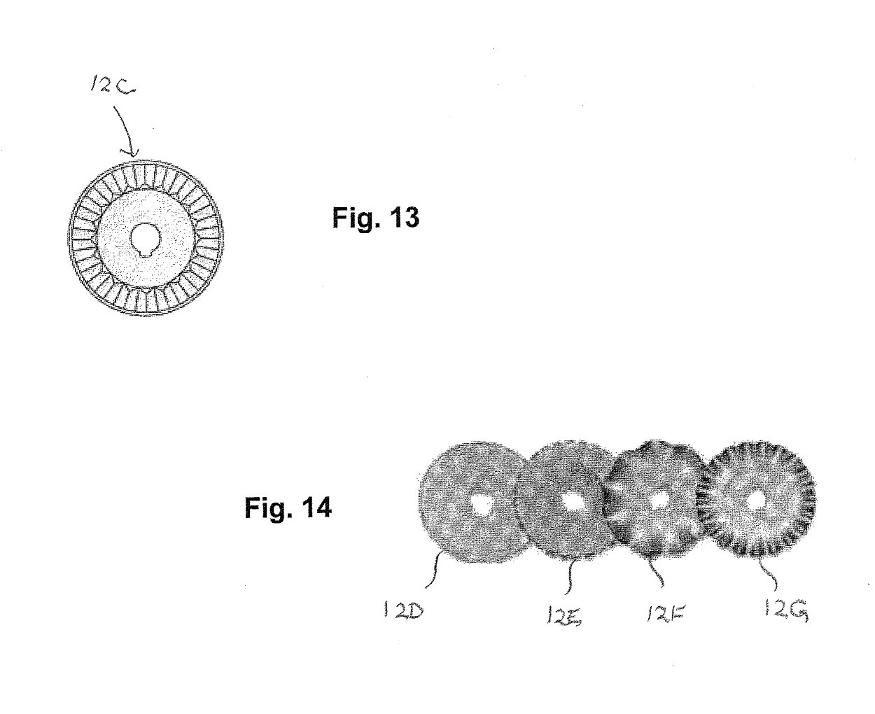

The rotary cutter 10 also functions to house and/or mount at one side a replacement blade assembly 50 for mounting the blade for rotation in the illustrated embodiment and for dismounting the blade and ejecting the blade from the cutter. The housing also receives replacement blades designated as 12A and 12B with central openings 14A and 14B, respectively. Two representative replacement blades are illustrated for purposes of description. It should be understood that blades 12A and 12B may be specialty blades such as a pinking blade 12C (FIG. 13) or other blades including a straight blade 12D, a perforated blade 12E, a wave blade 12F, and a pinking blade 12G (FIG. 14). The cartridge 30 typically has two blades, but may also include one blade.

The forward portion of the housing extends radially beyond the mounted blade in a protective nose 28 to provide a protection against the cutting surface of the blade. The housing also provides an opening 40 which allows the blade to be exposed for cutting purposes upon manual depression of a trigger 42. The trigger 42 is typically a spring biased so that the rotary cutter is normally configured in a protected position where the blade is not exposed exteriorly of the housing for cutting purposes. A dual positionable lock button 44 at the top of the housing is operable to lock the trigger 42 at the protective or operative positions.

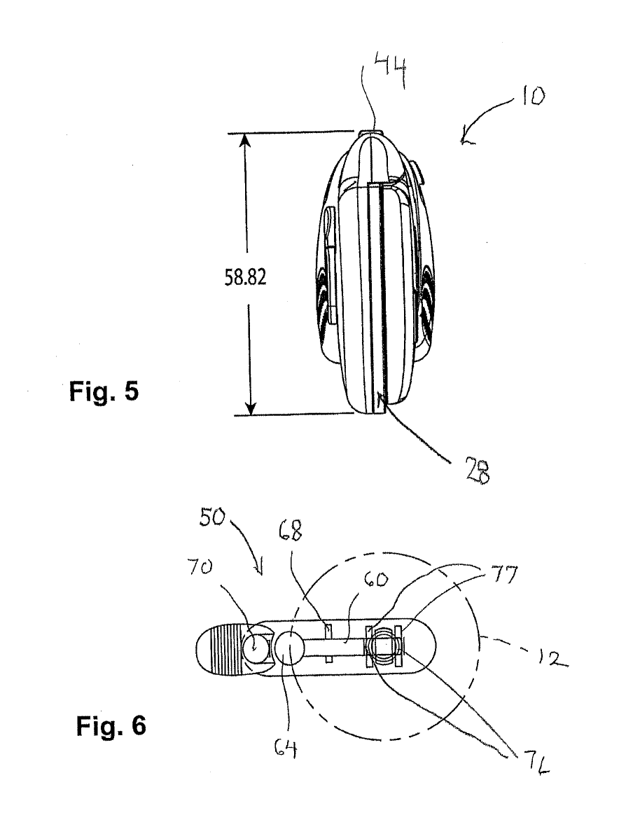

With reference to FIGS. 6-12, one embodiment of a blade replacement mechanism is generally designated by the numeral 50. Upon appropriate action by the operator via a dual action button 70, the blade replacement mechanism 50 functions to eject a blade 12 which has been spent and reloads a new replacement blade 12A from a replacement cartridge 30 having a blade receptacle 32 mounted within or to the housing of the rotary cutter. The blade is designated by the numeral 12 and replacement blades are designated as 12A and 12B in the drawings. Although blades 12A and 12B are illustrated of identical type, they may be of different types.

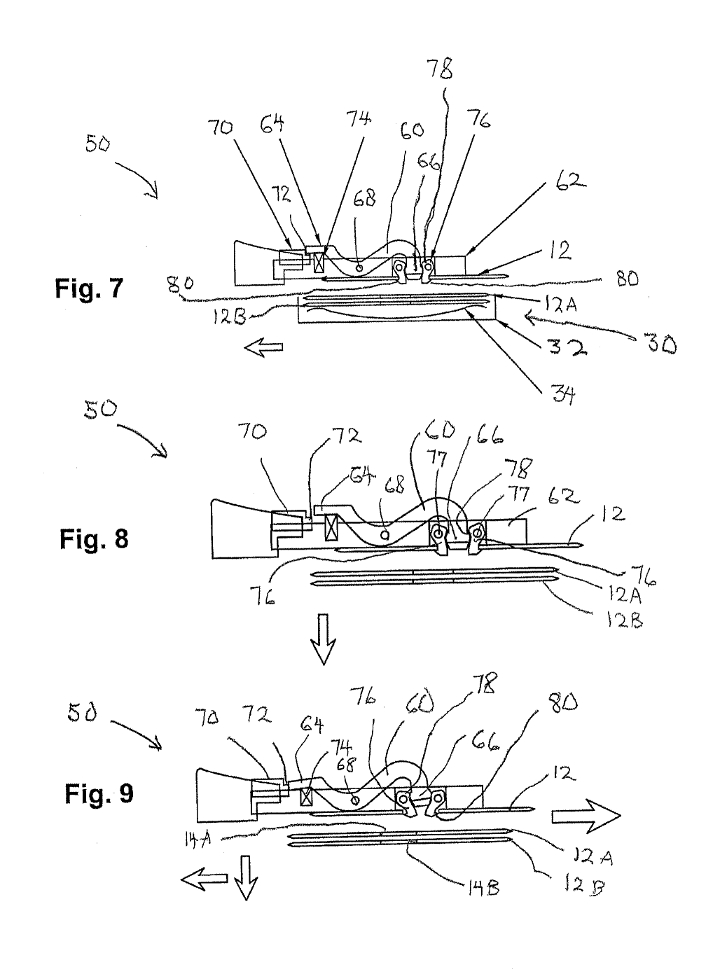

With reference to FIG. 7, a crank-like pivotal lever arm 60 has an opposed actuating end 64 and a working end 66. The lever arm is mounted to a support 62 about an intermediate pivot 68. The lever arm 60 has a double inverted U-shaped configuration. In the operative position wherein the blade is mounted for usage illustrated in FIG. 7, the actuating end 64 rests on a catch 72. The catch 72 is operatively connected to a button 70 and is laterally displaceable. The pivotal lever arm 60 is biased by a spring 74, which engages the underside of the actuating end 64, and is urged clockwise toward the position illustrated in FIG. 7.

The support 62 also pivotally mounts at least two locking toggles 76 which pivot about axles 77 (FIG. 6). The toggles each have a geometrically configured follower surface 78 partially surrounding each pivot axis and a distal catch 80. The working end 66 of the lever arm forms a cam surface which interacts with the followers 78 of the toggles 76 so that the toggles 76 are forced to either a retracted release position or an extended locking position, such as illustrated in FIG. 7.

The catches 80 engage against the side of the blade and therefore capture and lock the blade to the support. It is appreciated, however, that the blade is capable of rotation about the axis through the blade opening 14 when the toggles 76 retain the blade 12. As further illustrated in FIG. 7, the receptacle 30 includes a leaf spring 34 which biases the replacement blades 12A, 12B toward the pivot arm 60.

With reference to FIG. 8, the button 70 may be retracted in the direction of the arrow. This laterally displaces the catch 72 and allows the catch 72 to disengage from the underside of the actuating end 64 of the lever arm 60.

With reference to FIG. 9, the actuating end 64 is depressed and the working end 66 is forced upwardly to inwardly retract the locking toggles 76 to release the blade 12. The blade is now free and is easily ejected from the housing. In some embodiments, the cutter is additionally shaped to free blade 12 from the cutter.

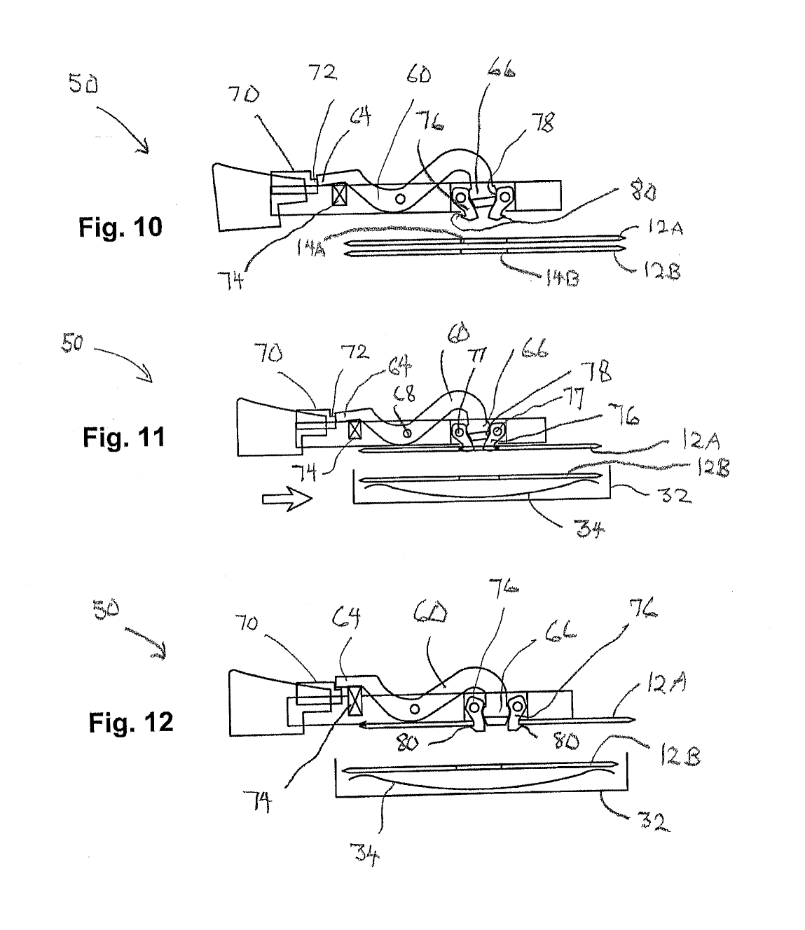

With reference to FIG. 10, the entire mechanism is moved back to the reload position by the dual action button 70 being pressed down and back in the directions of the arrows.

The replacement blade 12A is then reloaded as illustrated in FIG. 11. The spring 74 biases against the pivot arm so that the working end 66 is moved downwardly to engage the toggles 76 and secure the replacement blade 12A. The button 70 is then returned to the rest position when the catch 72 engages the activating end 64 to lock the pivoted lever arm 60 so that the replacement blade is now ready for usage as illustrated in FIG. 12.

It will be appreciated that the foregoing blade replacement mechanism 50 provides an efficient way in which the blade may be loaded without requiring the operator to physically engage the blade. The used blade may also be ejected from the rotary cutter housing without the operator touching the blade. In some embodiments, replacement blades may be easily loaded into the housing and/or removed from the housing when the replacement blades are spent.

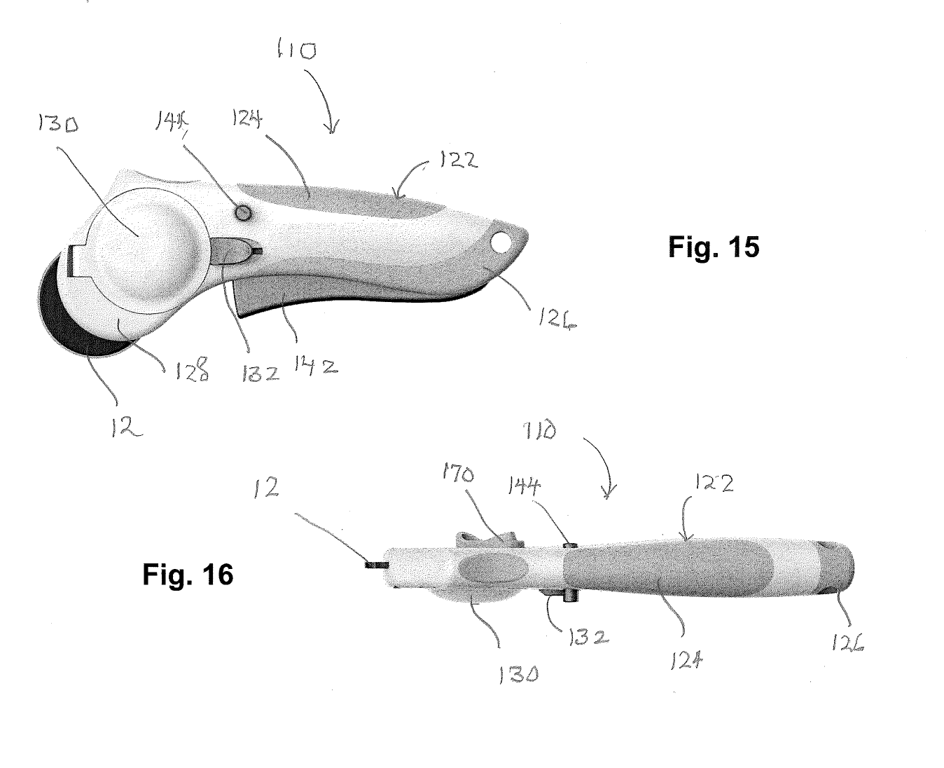

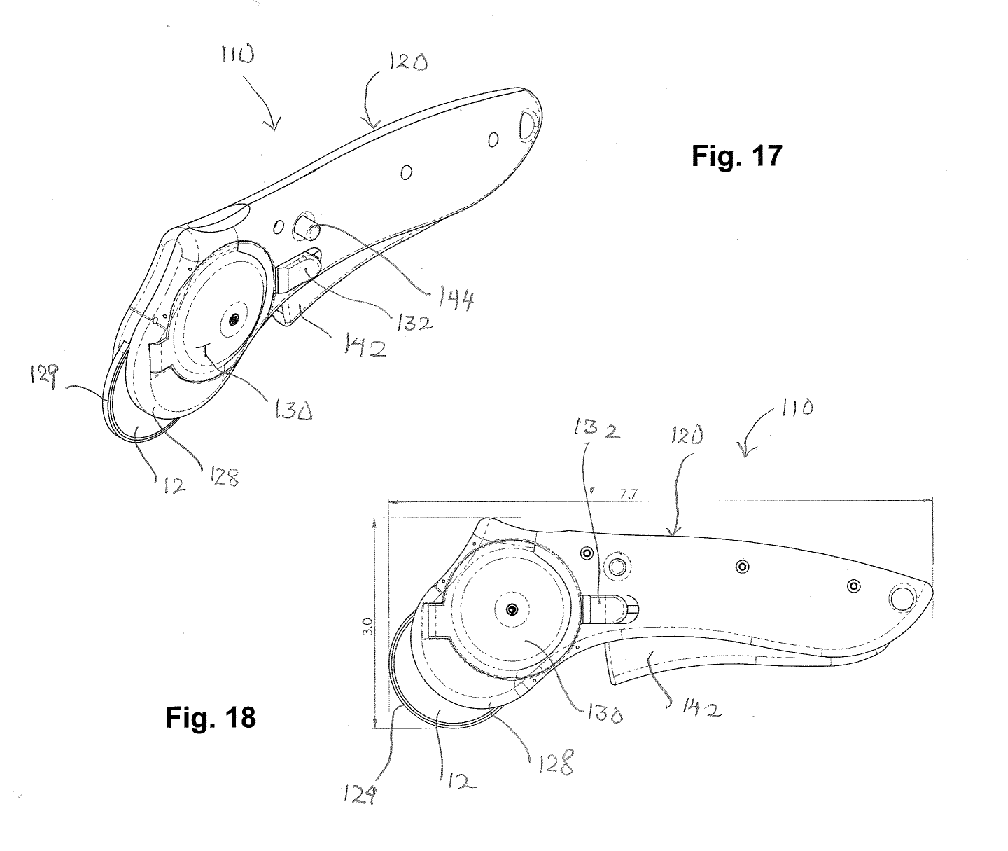

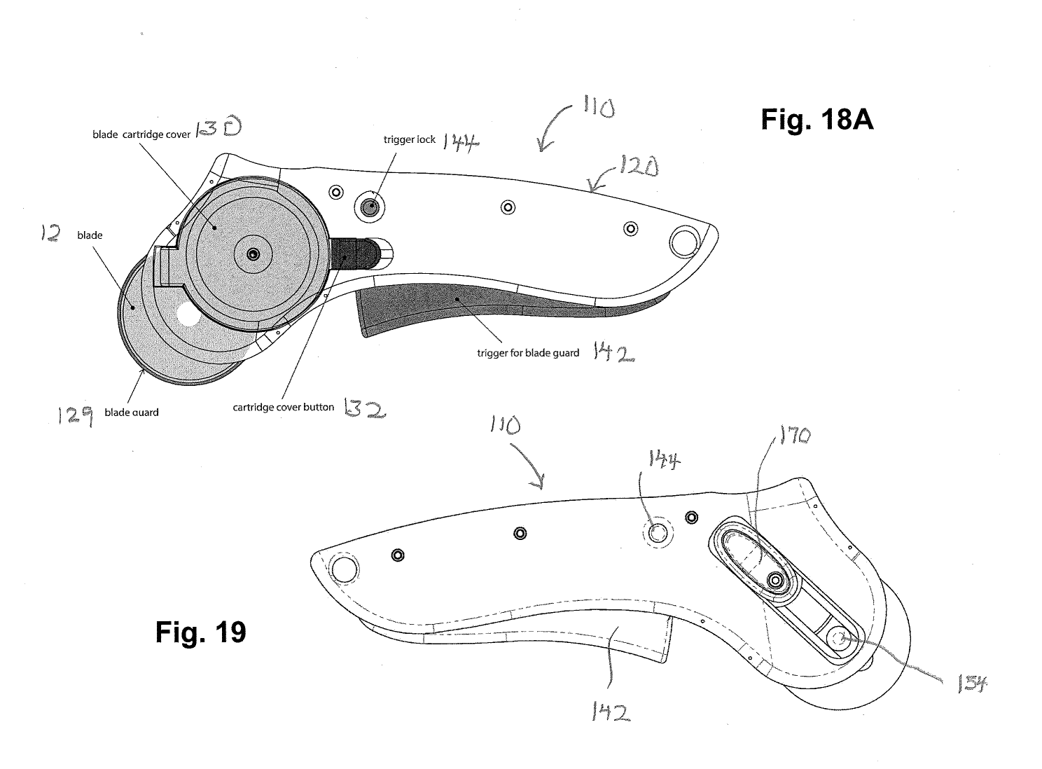

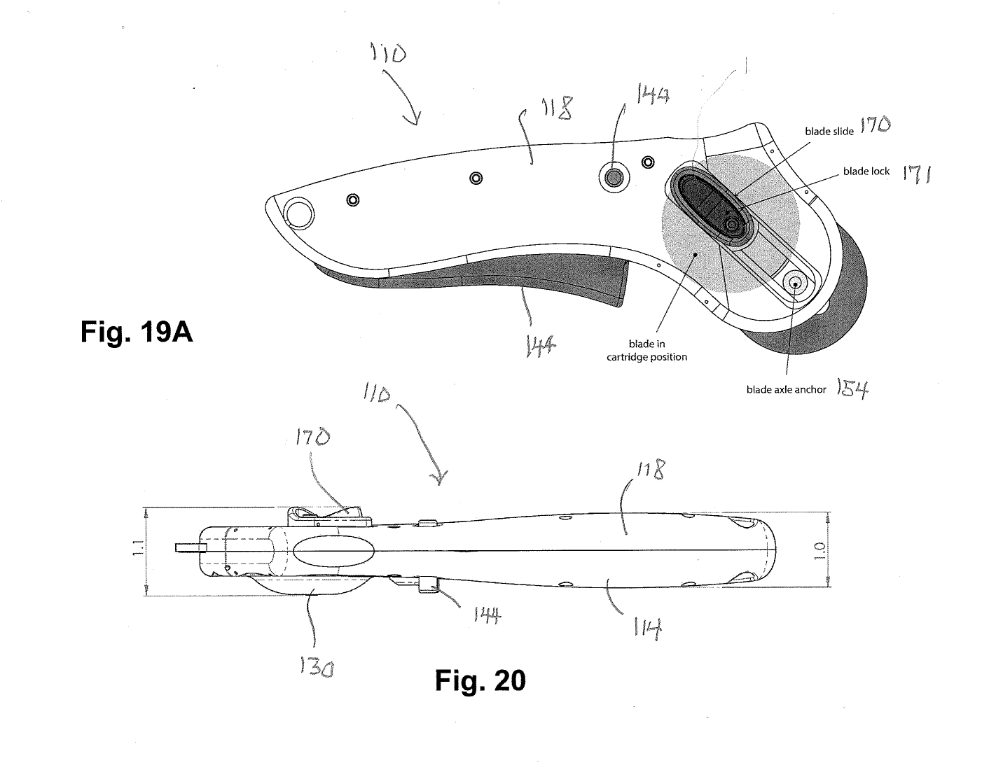

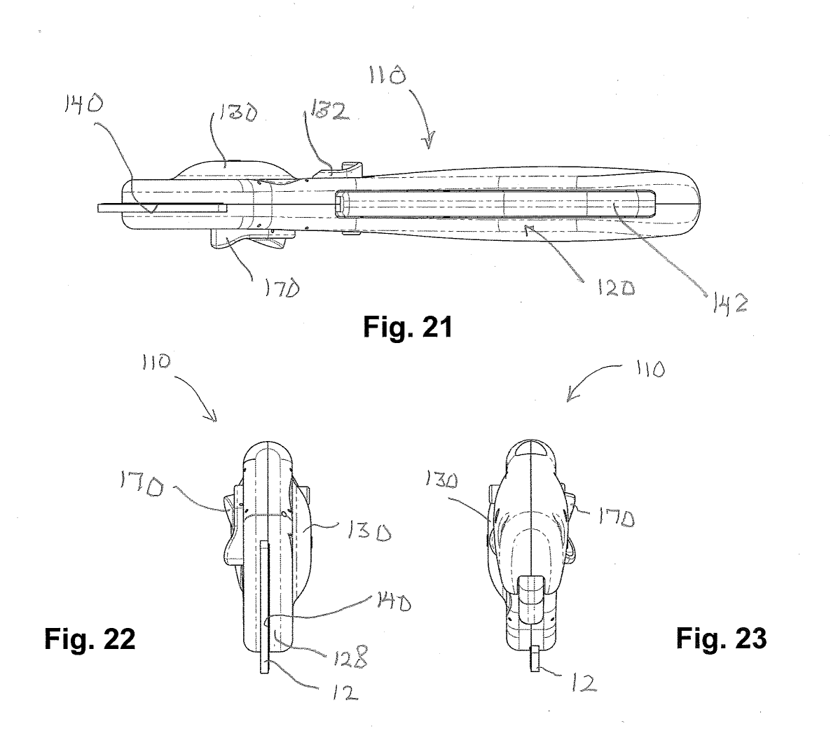

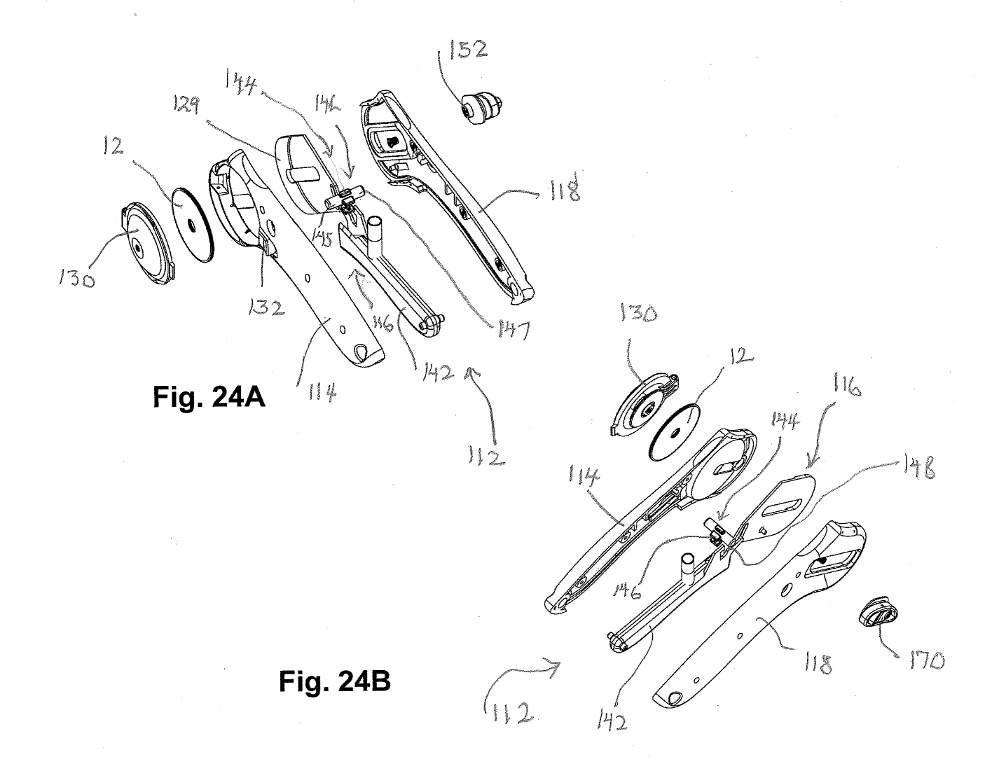

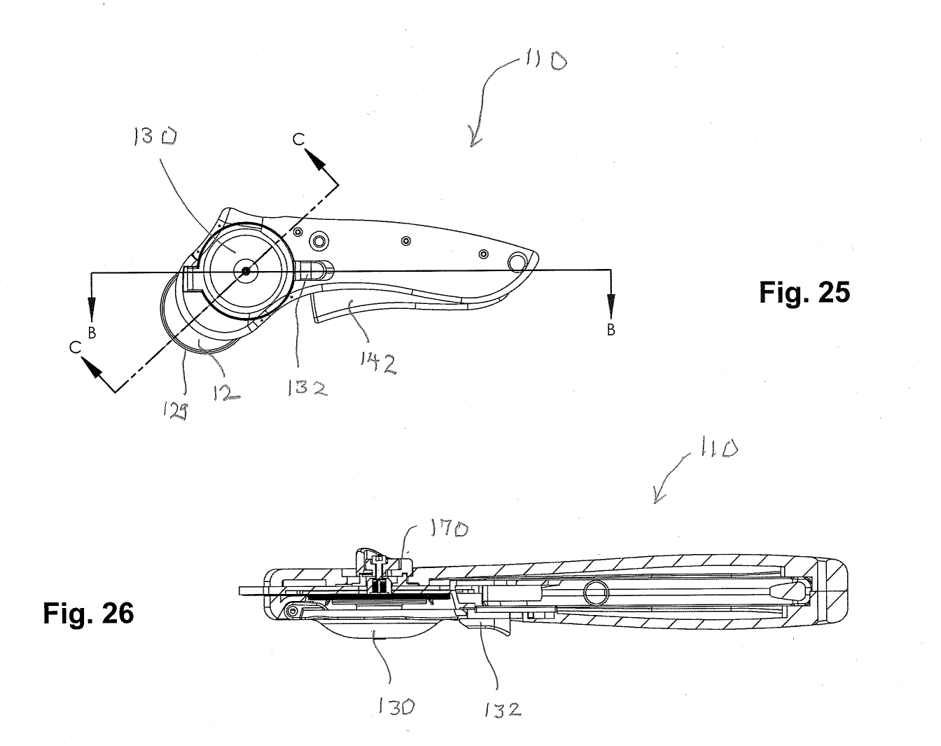

With reference to FIGS. 15-29B, a second embodiment of a rotary cutter is generally designated by the numeral 110.

The rotary cutter 110 has a housing 112 comprising a front housing assembly 114, an intermediate guard/trigger assembly 116 and a rear housing assembly 118. The housing 112 forms a handle 122 having a contoured form. The handle also has a pair of grip portions 124 and 126 configured to facilitate the manual gripping of the cutter. The housing 112 functions to provide a protective cover for the rotary blades, which in the illustrated embodiment, are designated as blades 12 each having a central opening 14 for a 45 mm blade. It should be appreciated that this rotary cutter 110 is also configured and dimensioned for blades of various sizes and types. The blades 12 are received in a blade receptacle 121. The receptacle 121 typically initially has three to six blades, but may also include one or other numbers of blades.

The rotary cutter 110 also functions to house and/or mount at one side a replacement blade assembly 150 for mounting the blade for rotation in the illustrated embodiment and for dismounting the blade and ejecting the blade from the cutter. For some embodiments, the replacement blade assembly may be similar in form and function to replacement blade assembly 50.

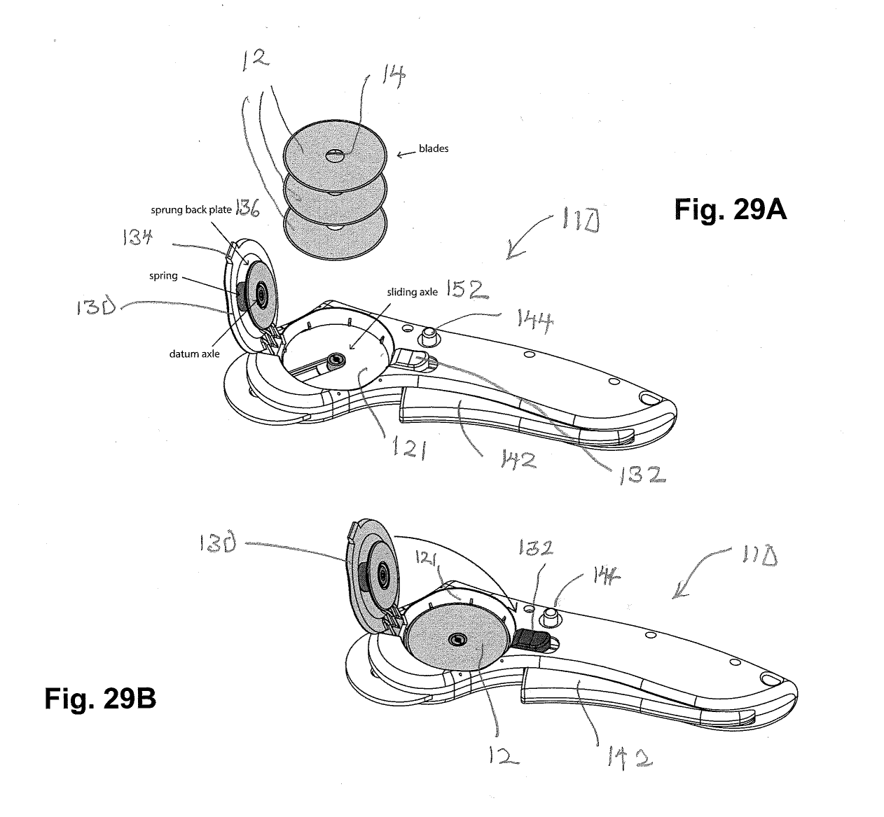

With reference to FIGS. 29A and 29B, a plurality of blades are removeably retained to the housing by a hinged blade cartridge cover 130 which is secured in a closed position by spring loaded retainer button 132 engaging a tab 134 of the cover. The hinged cover has a spring loaded back plate 136 which engages against the blade stack.

The forward portion of the housing 120 extends radially beyond the mounted blade in a protective nose 128 to provide a protection against the cutting surface of the blade. The housing also has a protective guard 129 having a slot 140 which allows the blade to be exposed for cutting purposes upon manual depression of an elongated trigger 142. The trigger 142 is pivotal and spring biased so that the rotary cutter is normally configured in a protected position where the blade is not exposed exteriorly of the housing for cutting purposes. A dual positionable lock button 144 at an upper portion of the housing has transversely opposed pin segments 145 and 147 and an intermediate wedge 146 which is operable to obstruct a tortuous channel 148 exteriorly from the trigger 142 to lock the trigger and hence the rotary cutter at the protective or operative positions. In a secured transverse position, the channel 146 slides over segment 147 and thus allows the trigger and rotary cutter to move between operative and blade protective positions.

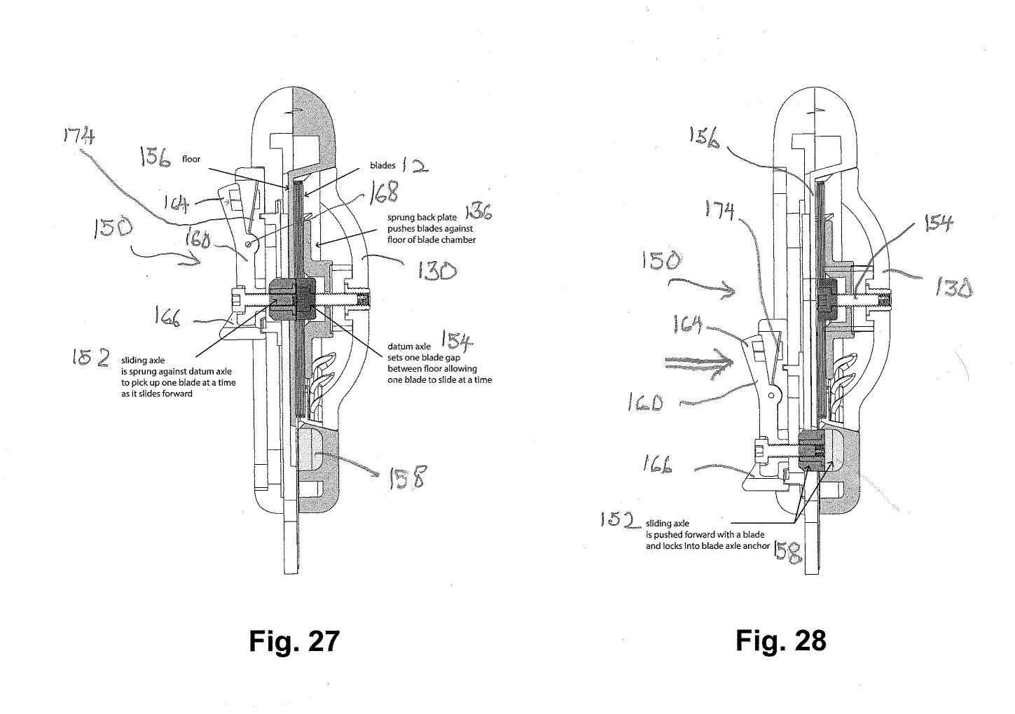

With additional reference to FIGS. 27 and 28, upon appropriate action by the operator via a dual action slide button 170 having a lock portion 170, the blade replacement mechanism 150 employs a sliding axle 152 which functions to eject a blade 12 that has been spent and reloads a new replacement blade 12 from a the blade receptacle 121 mounted within the housing of the rotary cutter. The sliding axle 152 is sprung transversely against a datum axle 154 to pick up one blade at a time when it is pushed to slide forward. The receptacle cover 130 includes a spring loaded back plate 136 which biases the replacement blades toward the floor 156. The datum axle 154 is adjustable to set a blade gap between floor 156 of the receptacle 121 allowing one blade. At the forward position, the sliding axle 152 locks with the blade axle anchor 158. It is appreciated that the blade is capable of rotation about the axle 152 through the blade opening 14.

A crank-like pivotal lever arm 160 has an opposed actuating end 164 and a working end 166 which carries the sliding axle 152. The lever arm is mounted to a support about an intermediate pivot 168. The actuating end 164 is operatively connected to the button 170 and is forwardly and laterally displaceable. The pivotal lever arm 160 is biased by a spring 174, which engages the underside of the actuating end 164, and is urged toward the position illustrated in FIG. 27.

With reference to FIG. 28, the button 170 may be depressed in the direction of the arrow. This laterally displaces the sliding axle 152 and allows the axle to disengage from the blade. The blade is now free and is easily ejected from the housing.

The entire mechanism 150 is moved back to the reload position by the dual action button 170 being pressed down and back in the directions of the arrows.

The replacement blade 12 is then reloaded as illustrated in FIG. 27. The button 170 is then returned to the operative position when the sliding axle 152 engages the axle anchor 156 and is locked so that the replacement blade is now ready for usage as illustrated in FIG. 28.

While preferred embodiments of the foregoing rotary cutter and method therefor have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A rotary cutter comprising:
a body comprising a handle and defining a cutter opening;
a reservoir of rotary blades disposed in said body;
a member moveable between a protective and an exposed position of a rotary blade;
a releasable blade receiver assembly mounted to said body comprising:
a pivoted lever arm having an actuator;
a spring biasing said pivoted lever arm to a first position;
a bottom structure engageable with said lever arm at said first position;
a slide axle assembly activatable by said actuator to engage a rotary blade to permit rotation thereof and to disengage said blade;
a button exteriorly of said body actuatable for retracting said slide axle assembly;
so that said slide axle assembly is engageable with a blade in a first button position and is disengageable from the blade to release the blade in a second position.

2. The rotary cutter of claim 1 wherein said rotary blades are substantially identical.

3. The rotary cutter of claim 1 wherein said rotary blades are selected from the group consisting of a rotary pinking blade, a straight blade, a perforator blade and a wave blade.

4. The rotary cutter of claim 1 wherein in the protective position, the rotary blade is not exteriorly exposed for cutting.

5. The rotary cutter of claim 1 further comprising a lock which locks the cutter blade at a protective or an exposed position.

6. A method for replacing a blade in a rotary cutter without a user contacting the blade comprising:
sliding a button;
depressing the button to release the blade;
ejecting the blade from the cutter;
sliding the button to engage a replacement blade; and
moving the button to secure the replacement blade for usage.

7. The method of claim 6 further comprising transforming the replacement blade between a protective and an exposed operative position.

8. The method of claim 7 further comprising locking the replacement blade at the protective or exposed operative position.
